(19) United States
(12) Patent Application Publication
(10) Pub. No.: US 2026/0007954 A1
(43) Pub. Date: Jan. 8, 2026

(54) Game Control Device Having Novel Key Layout

(71) Applicant: Shenzhen Qanba Technology Development Co., Ltd., Shenzhen (CN)

(72) Inventor: Kai Liu, Shenzhen (CN)

(21) Appl. No.: 19/174,831

(22) Filed: Apr. 9, 2025

(30) Foreign Application Priority Data
Jul. 3, 2024 (CN) 2024215683734

(51) Int. Cl. A63F 13/24

(52) U.S. Cl. CPC A63F 13/24

(57) ABSTRACT

The present disclosure discloses a game control device having a novel key layout, including a control panel and multiple keys arranged on the control panel. A first key combination area and a second key combination area are formed on the control panel. A first key combination is arranged in the first key combination area. A second key combination is arranged in the second key combination area. The first key combination includes four keys arranged in a first preset line type. The second key combination includes four keys arranged in a second preset line type and four keys arranged in a third preset line type. Therefore, the game control device disclosed by the present disclosure is capable of improving the operating experience of a player as a whole.

### TECHNICAL FIELD

The present disclosure relates to the field of game peripherals, and in particular to a game control device having a novel key layout.

### BACKGROUND

Keys in an existing game control keyboard are usually arranged at specific positions according to pressing habits of players. However, the arrangement mode or layout mode of existing keys on the keyboard still needs to be improved to better fit the operating experience of the players.

### SUMMARY

To solve the above problem, an objective of the present disclosure is to provide a game control device having a novel key layout capable of improving the operating experience of a player.

The present disclosure achieves the above objective by the following technical solutions. The present disclosure provides a game control device having a novel key layout, including a control panel and multiple keys arranged on the control panel, where a first key combination area and a second key combination area are formed on the control panel, a first key combination is arranged in the first key combination area, a second key combination is arranged in the second key combination area, the first key combination includes four keys arranged in a first preset line type, and the second key combination includes four keys arranged in a second preset line type and four keys arranged in a third preset line type.

In the present disclosure, the first key combination arranged in the first key combination area may be controlled by a left hand of a player. The second key combination arranged in the second key combination area may be controlled by a right hand of the player The four keys in the first key combination arranged in the first preset line type can fit an operating hand feeling of the left hand of the player. The eight keys in the second key combination respectively arranged in the second preset line type and the third preset line type can fit an operating hand feeling of the right hand of the player. Therefore, the game control device disclosed by the present disclosure can improve the operating experience of the player as a whole.

Preferably, a sixth key is arranged at a bottom end between the first key combination and the second key combination area.

Preferably, the second preset line type and the third preset line type ascend gradually.

Preferably, the second preset line type and the third preset line type are arc-shaped and same in curvature.

Preferably, the first preset line type is arc-shaped and is basically located on a same horizontal line with the four keys arranged in the second line type.

Preferably, the game control device having a novel key layout further includes a seventh key arranged in the second key combination area with a maximum surface area and/or volume, and the seventh key is arranged close to the sixth key.

Preferably, the game control device having a novel key layout further includes a fifth key arranged in the first key combination area, and the fifth key is arranged close to a sixth key.

Preferably, the game control device having a novel key layout further includes a sixteenth key arranged above the four keys arranged in the first preset line type, and a seventeenth key and an eighteenth key arranged above the four keys arranged in the second line type and the four keys arranged in the third preset line type.

Preferably, the sixteenth key, the seventeenth key, and the eighteenth key are non-function keys.

Preferably, the multiple keys are spaced apart from each other.

The present disclosure has the following beneficial effect: By rearranging existing keys, the game control device disclosed by the present disclosure can improve the operating experience of the player as a whole.

### BRIEF DESCRIPTION OF FIGURES

To describe the technical solutions in embodiments of the present disclosure or in existing technologies more clearly, accompanying drawings required for describing the embodiments or existing technologies are briefly described below. Apparently, the accompanying drawings in the following description show some embodiments of the present disclosure, and a person of ordinary skill in the art may still derive other drawings from these accompanying drawings without creative efforts. To make the objectives, technical solutions, and advantages of the present disclosure more clearly, the technical solutions of the present disclosure will be described in detail below.

FIG. 1 is a schematic diagram of a key arrangement on a game control device involved in the present disclosure.

FIG. 2 is a schematic diagram of key names in an embodiment involved in the present disclosure.

FIG. 3 is an overall structural diagram of the game control device involved in the present disclosure.

1, game control device; 10, key area; 20, functional area; 30, bearing area; 11, key; 12, control panel; A1, first key combination area; and A2, second key combination area.

### DETAILED DESCRIPTION

In order to make objectives, technical solutions, and advantages of the present disclosure clearer, the technical solution of the present disclosure will be further described in detail below. Apparently, the described embodiments are merely a part of embodiments of the present disclosure and are not all the embodiments. On the basis of the embodiments in the present disclosure, all other implementations obtained by a person of ordinary skill in the art without creative efforts fall into the scope of protection of the present disclosure.

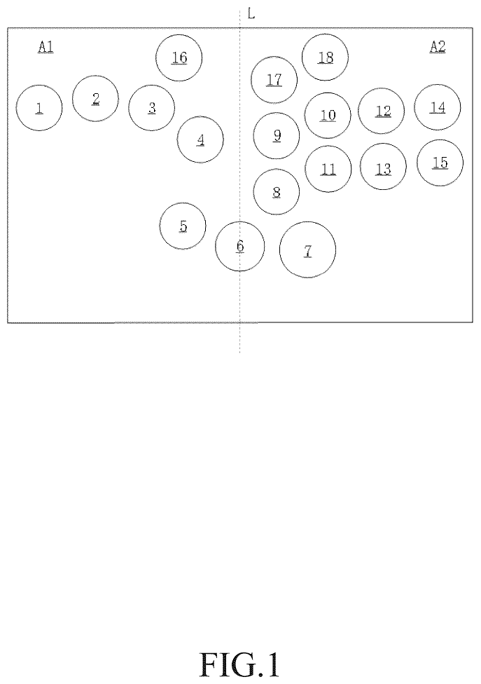

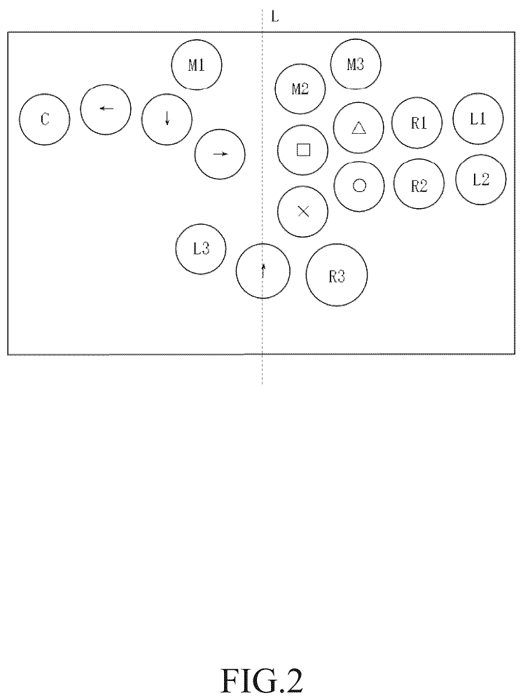

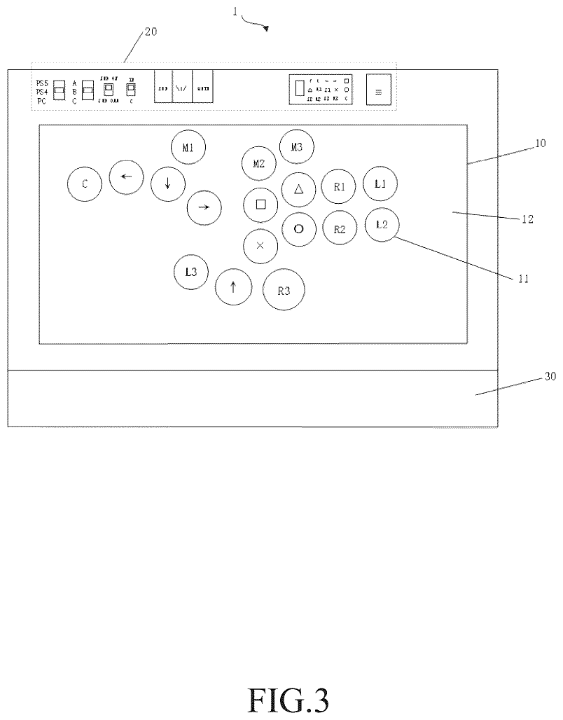

FIG. 1 is a schematic diagram of a key arrangement on a game control device 1 involved in the present disclosure (corresponding keys are respectively represented by Arabic numerals). FIG. 2 is a schematic diagram of key names in an embodiment involved in the present disclosure. FIG. 3 is an overall structural diagram of the game control device 1 involved in the present disclosure.

The present disclosure provides a game control device 1 having a novel key layout. The game control device may also be referred to as a game control device, a game keyboard, a flat keyboard or a control keyboard, or the like.

In some implementations, the game control device 1 may include a control panel 12 and multiple keys 11 arranged on the control panel.

In some implementations, the control panel 12 may have a preset shape. The preset shape may be a rectangle or another irregular figure. In some implementations, the multiple keys 11 may be uniformly distributed on the control panel 12.

In some implementations, a first key combination area A1 and a second key combination area A2 may be formed on the control panel 12. A first key combination is arranged in the first key combination area A1, and a second key combination is arranged in the second key combination area A2.

In some implementations, the first key combination may include four keys arranged in a first preset line type. For example, the four keys may respectively be a first key, a second key, a third key, and a fourth key (represented by corresponding Arabic numerals in FIG. 1).

In some implementations, the second key combination may include four keys arranged in a second preset line type. For example, the four keys may respectively be a ninth key, a tenth key, a twelfth key, and a fourteenth key (represented by corresponding Arabic numerals in FIG. 1).

In some implementations, the second key combination may include four keys arranged in a third preset line type. For example, the four keys may respectively be an eighth key, an eleventh key, a thirteenth key, and a fifteenth key (represented by corresponding Arabic numerals in FIG. 1).

In the present disclosure, the first key combination arranged in the first key combination area A1 may be controlled by a left hand of a player. The second key combination arranged in the second key combination area A2 may be controlled by a right hand of the player. The four keys in the first key combination arranged in the first preset line type can fit an operating hand feeling of the left hand of the player. The eight keys in the second key combination respectively arranged in the second preset line type and the third preset line type can fit an operating hand feeling of the right hand of the player. Therefore, the game control device 1 disclosed by the present disclosure can improve the operating experience of the player as a whole.

In some implementations, a sixth key is arranged at a bottom end between the first key combination and the second key combination area (represented by the corresponding Arabic numeral 6 in FIG. 1). In some implementations, the sixth key may be arranged at a bottommost position of the first key combination area A1 and the second key combination area A2. In some implementations, the sixth key may also be arranged at a bottommost position just after the seventh key in the first key combination area A1 and the second key combination area A2.

In some implementations, the second preset line type and the third preset line type ascend gradually. Ascending gradually means that the positions of the four keys arranged in the second preset line type are raised gradually, and the positions of the four keys arranged in the third preset line type are raised gradually. In other words, the position of the tenth key is higher than that of the ninth key, the position of the twelfth key is higher than that of the tenth key, and the position of the fourteenth key is higher than that of the twelfth key; and the position of the eleventh key is higher than that of the eighth key, the position of the thirteenth key is higher than that of the eleventh key, and the position of the fourteenth key is higher than that of the twelfth key.

In some implementations, the second preset line type and the third preset line type may be arc-shaped. In some implementations, the curvatures of arc-shaped may be same. In this case, when controlling the above two groups of keys with the right hand, the player can alternate the position downward or upward with a same hand shape, so that the operational errors of the player can be reduced.

In some implementations, the first preset line type is arc-shaped and the four keys arranged in the second preset line type are basically located on a same horizontal line. In this case, when the player operates corresponding keys, the left hand and the right hand are basically located on the same horizontal line, which can better conform to the operating habit of the player.

In some implementations, the game control device having a novel key layout further includes a seventh key arranged in the second key combination area with a maximum surface area and/or volume, and the seventh key is arranged close to the sixth key. The maximum surface area means that the area occupied by the seventh key on the control panel 12 is the maximum.

In some implementations, the game control device 1 may further include a fifth key arranged in the first key combination area, and the fifth key may be arranged close to the sixth key.

In some examples, referring to FIG. 1, the game control device 1 may include 18 keys. In some implementations, 6 keys may be arranged in the first key combination area A1. In some implementations, 11 keys may be arranged in the first key combination area A1. In some implementations, the last key may be arranged between the first key combination area A1 and the second key combination area A2. In some implementations, this key may be arranged on a central axis L of the key combination area.

In some implementations, the game control device 1 may further include a sixteenth key arranged above the four keys arranged in the first preset line type. In some implementations, the game control device 1 may further include a seventeenth key and an eighteenth key arranged above the four keys arranged in the second line type and the four keys arranged in the third preset line type.

In some implementations, the sixteenth key, the seventeenth key, and the eighteenth key may be non-function keys. The non-function keys mean that the keys will not have any function in an initial state. But in this case, the non-function keys may be endowed with functions through a certain operation. For example, when the player further hopes that the sixteenth key is a key that controls an upward movement, the function of the sixth key is replaced to the sixteenth key, so that the sixteenth key has an upward moving function. In some implementations, the multiple keys may be spaced apart from each other. In some implementations, distances from each other of the multiple keys may be consistent.

Referring to FIG. 2, specifically, in some implementations, the game control device 1 shows 15 common keys and 3 non-function keys. The 15 common keys are respectively four direction keys: “↑” key, “↓” key, “←” key, and “→” key; and 11 common function keys: “L1” key, “R1” key, “L2” key, “R2” key, “L3” key, “R3” key, “C” key, “□” key, “o” key, “Δ” key, and “x” key. The 11 common function keys may include an enter key, a return key, a skip key, and the like. For different host machines (for example, PS5, PS4, PC, and the like), the 11 common function keys may have different functions, which are not introduced herein one by one. The 3 non-function keys may respectively be an “M1” key, an “M2” key, an “M3” key, and the like. Key codes in FIG. 1 may be in one-to-one correspondence to positions of key names in FIG. 2.

Referring to FIG. 3, in some implementations, FIG. 2 may be a partial schematic diagram of the control panel in FIG. 3. In other words, blank areas may exist on the left and right sides of the first key combination area A1 and the second key combination area A2. The multiple keys 11 and the control panel may jointly form a key area 10.

Referring to FIG. 3, in some implementations, the game control device 1 may further include a function area 20. Multiple function keys may be arranged in the function area 20, for example, an indicator light key, a switch key, an adjustment key for endowing the non-function keys with functions (or reversing functional positions of the keys), and the like.

In some implementations, the game control device 1 may further include a bearing area 30. The bearing area may be configured to bear the hand or wrist of the player.

The present disclosure has the following beneficial effect. By rearranging existing keys 11, the game control device disclosed by the present disclosure can improve the operating experience of the player as a whole.

The above is merely the specific implementation of the present disclosure and is not intended to limit the scope of protection of the present disclosure. Any variations or replacements apparent to a person skilled in the art within the technical scope disclosed by the present disclosure shall fall within the scope of protection of the present disclosure. Therefore, the scope of protection of the present disclosure shall be subject to the scope of protection of the claims.

What is claimed is:

1. A game control device having a novel key layout, comprising a control panel and a plurality of keys arranged on the control panel, wherein a first key combination area and a second key combination area are formed on the control panel, a first key combination is arranged in the first key combination area, a second key combination is arranged in the second key combination area, the first key combination comprises four keys arranged in a first preset line type, and the second key combination comprises four keys arranged in a second preset line type and four keys arranged in a third preset line type.

2. The game control device having a novel key layout according to claim 1, wherein a sixth key is arranged at a bottom end between the first key combination and the second key combination area.

3. The game control device having a novel key layout according to claim 1, wherein the second preset line type and the third preset line type ascend gradually.

4. The game control device having a novel key layout according to claim 1, wherein the second preset line type and the third preset line type are arc-shaped and same in curvature.

5. The game control device having a novel key layout according to claim 1, wherein the first preset line type is arc-shaped and is basically located on a same horizontal line with the four keys arranged in the second line type.

6. The game control device having a novel key layout according to claim 2, further comprising a seventh key arranged in the second key combination area with a maximum surface area and/or volume, wherein the seventh key is arranged close to the sixth key.

7. The game control device having a novel key layout according to claim 1, further comprising a fifth key arranged in the first key combination area, wherein the fifth key is arranged close to a sixth key.

8. The game control device having a novel key layout according to claim 1, further comprising a sixteenth key arranged above the four keys arranged in the first preset line type, and a seventeenth key and an eighteenth key arranged above the four keys arranged in the second line type and the four keys arranged in the third preset line type.

9. The game control device having a novel key layout according to claim 8, wherein the sixteenth key, the seventeenth key, and the eighteenth key are non-function keys.

10. The game control device having a novel key layout according to claim 1, wherein the plurality of keys are spaced apart from each other.
